(19) United States
(12) Patent Application Publication
(10) Pub. No.: US 2026/0254258 A1
(43) Pub. Date: Aug. 27, 2026

(54) ENERGY CONVERTER AND ASSOCIATED DOOR CLOSER

(71) Applicant: ASSA ABLOY AB, Stockholm (SE)

(72) Inventor: Martin Englund, Handen (SE)

(21) Appl. No.: 19/489,655

(22) PCT Filed: Jun. 3, 2024
(86) PCT No.: PCT/EP2024/065210

§ 371 Date: Dec. 3, 2025

(30) Foreign Application Priority Data
Jun. 5, 2023 (SE) 2350685-0

(51) Int. Cl. H02J 7/14; E05F 15/603; H02J 7/96; H02M 7/06; H02M 7/219

(52) U.S. Cl. CPC H02J 7/1492; H02J 7/1415; H02J 7/96; H02M 7/066; H02M 7/219; E05F 15/603; E05Y 2400/614; H02J 2207/20

(57) ABSTRACT

It is provided an energy converter (10) for converting mechanical energy to electrically stored energy. The energy converter (10) comprises: a generator (9) comprising at least one winding (3); an energy storage device (7); a rectifier (27) provided between the generator and the energy storage device (7); a voltage boost circuit (4, 6) that is selectively activated; a control circuit (8) that is configured to: detect that a voltage that is energised by the generator (9) is below a threshold voltage; and activate the voltage boost circuit (4, 6) of the door closer to increase the voltage supplied to the energy storage device (7). A corresponding door closer is also provided.

### TECHNICAL FIELD

The present disclosure relates to the field of energy conversion and in particular to energy conversion from mechanical energy to electrical energy to an energy storage device.

### BACKGROUND

Door closers have been used for a long time to provide reliable closing of doors. This function can e.g. be used to improve physical security, climate control or to comply with fire regulations. Traditional door closers are based on mechanical energy storage that is loaded when a person opens the door. The mechanical energy is then exploited to close the door. Hydraulics or pneumatics can be used to control the speed of closing to prevent slamming.

It has been proposed to provide door closers with a generator to convert mechanical energy from door closing movement to electrical energy that can be stored, e.g. in a battery. The generator acts as braking force on the door closing.

However, due to the capabilities of receiving energy in the battery, the battery under some conditions is unable to accept charging energy, leading to the braking effect of the generator being suspended or significantly reduced. Once the battery is again able to accept the charging energy, the generator is again active in energy conversion and acts as a braking force.

Such intermittent braking is undesirable for the user experience and can lead to inefficient energy transfer.

### SUMMARY

One object is to provide an improved energy converter that is better suited to transfer energy to an energy storage device with requirements to accept charging energy.

According to a first aspect, it is provided an energy converter for converting mechanical energy to electrically stored energy. The energy converter comprises: a generator comprising at least one winding; an energy storage device; a rectifier provided between the generator and the energy storage device; a voltage boost circuit that is selectively activated; a control circuit that is configured to: detect that a voltage that is energised by the generator is below a threshold voltage; and activate the voltage boost circuit of the energy converter to increase the voltage supplied to the energy storage device.

The voltage energised by the generator may be a DC output voltage of the rectifier. Alternatively, the voltage energised by the generator may be a AC output voltage of the generator.

The voltage boost circuit may comprise at least one winding of the generator and at least one switch.

The switch may be arranged to selectively connect and disconnect energy transfer from the generator to the energy storage device.

The at least one switch may be provided in the rectifier.

The rectifier may comprise diodes, in which case at least one of the at least one switch is provided in parallel to one of the diodes.

The generator may be a multi-phase generator, in which case at least one of the at least one switch is provided between two phases of the multi-phase generator.

The control circuit may be configured to select the at least one switch from a plurality of potential switches, in which case the control circuit is configured to distribute the selection over time among all of the plurality of potential switches.

The control circuit may be configured to distribute the selection over time among all of the plurality of potential switches to approach an even distribution among all of the plurality of potential switches.

The control circuit may further be configured to: determine a charge level in the energy storage device; and determine a threshold voltage based on the charge level.

The voltage boost circuit may be a boost converter provided between the rectifier and the energy storage device.

The control circuit may comprise a processor; and a memory storing instructions that, when executed by the processor, cause the energy converter to perform the actions that the control circuit is mentioned to be configured to perform.

According to a second aspect, it is provided a door closer comprising the energy converter according to any one of the preceding claims.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIG. 2 is a schematic diagram illustrating component of the door closer of FIG. 1 according to one embodiment;

FIGS. 3A-E are schematic diagrams illustrating embodiments of voltage boost circuit that can be applied in the door closer of FIG. 2;

FIG. 4 illustrates an embodiment of a voltage boost circuit that is provided between the rectifier and the energy storage device of FIG. 2;

FIG. 5 is a schematic diagram illustrating an embodiment of the voltage boost circuit of FIG. 4;

FIG. 6 is a schematic graph illustrating how the threshold voltage can vary depending on charge level in the energy storage device; and

FIG. 7 is a schematic diagram illustrating components of the controller of FIG. 1 according to one embodiment.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

Embodiments presented herein provide improved energy transfer from a generator to an energy storage device. Specifically, when a voltage (e.g. DC bus voltage) supplied by the generator, falls below a threshold, a boost circuit is activated. In this way, the voltage level can be maintained across the energy storage device at a suitable level for charging. Consequently, mechanical energy is converted to electrical energy which is conditioned to suit the characteristics for charging the energy storage device.

This can e.g. be applied for door closers with energy harvesting, where any variation in charging energy results in variations in breaking energy of a closing door.

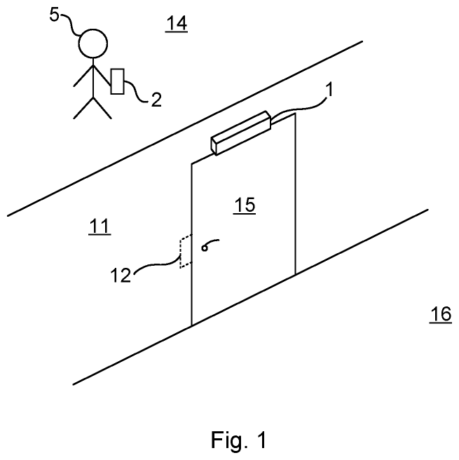

FIG. 1 is a schematic diagram illustrating an environment in which embodiments presented herein can be applied. Access to a first physical space 16 is restricted by a door 15. The door 15 stands between the first physical space 16 and a second physical space 14. The first physical space 16 can be inside the door 15 and the second physical space 14 can be outside the door 15. In order to unlock or lock the door 15, an electronic lock 12 is optionally provided. The barrier 15 is provided in a surrounding fixed structure 11, such as a wall or fence.

A user 5 is in the vicinity of the door 15. Optionally, the user carries an electronic key 2 in any suitable format that allows the electronic lock 12 to communicate (wirelessly or conductively) with the electronic key 2 to evaluate whether to grant access. For instance, the electronic key 2 can be in the form of a key fob, a key card, a hybrid mechanical/electronic key or embedded in a smartphone.

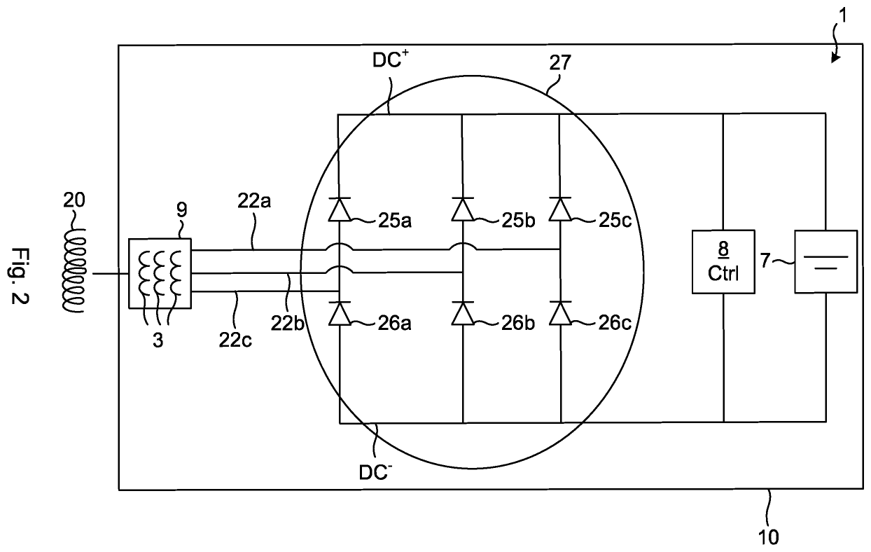

A door closer 1 is provided to provide controlled automatic closing of the door 15 after it is opened. When the user 5 opens the door 15, a spring (20 of FIG. 2) in the door closer 1 is deformed (e.g. extended, rotated, etc.) and is thereby loaded with mechanical energy. When the user 5 passes through the doorway and releases the door 15, the mechanical energy in the spring causes the door to close again. The door closer 1 can be provided such that is fixed both to the door 15 and the surrounding structure 11, to allow the spring to be loaded with mechanical energy when the door 15 opens, where the mechanical energy is subsequently exploited to close the door. As explained in more detail below, the door closer 1 comprises a generator and an energy storage device, which converts part of the mechanical energy to electric energy.

The electric energy can be used by the door closer e.g. for auxiliary functions, such as for communicating with external devices, for powering one or more sensors for detecting people and/or door status, for controlling fail-safe hold-open functionality, etc.

FIG. 2 is a schematic diagram illustrating component of the door closer 1 of FIG. 1 according to one embodiment.

The door closer comprises the spring 20, that is loaded with mechanical energy when the door is opened. The spring 20 can be of any type that enables storage of mechanical energy when the door is opened, for instance, a coil spring, torsion spring, etc. A generator 9 is used to convert at least part of the mechanical energy stored in the spring 20 to electrical energy, e.g. when the door is closing. When the generator 9 is active, this results in a breaking effect on door movement since some of the mechanical energy is converted to electrical energy. The door closer 1 can comprise various mechanical elements, such as gears, etc. (not shown) to provide mechanical energy of suitable characteristics for the generator 9, as well as for controlling closing times, torques and/or speeds of the closing door. In FIG. 2, the spring 20 is only shown schematically connected to provide mechanical energy to the generator 9 The generator 9 provides electrical energy in the form of alternating current (AC), in one or more phases. In the embodiment shown in FIG. 2, there are three phases of an AC output 22a, b, from the generator 9. However, it is to be noted that a single-phase (or any other number of phases) generator 9 can be used in the door closer, e.g. any suitable rotating electrical machine, such as a DC (direct current) motor or an AC motor operating in generator mode. The generator 9 comprises at least one winding 3 for inducing an electrical current based on mechanical movement. When there are multiple phases in the generator 9, there is at least one winding per phase.

The AC energy is converted to DC in a rectifier 27. The rectifier 27 can comprise one or more upper diodes 25a-c and one or more lower diodes 26a-c, respectively provided in relation to the AC output 22a-c for the different phases. In this way, the rectifier 27 provides DC energy is to a positive DC bus DC⁺and a negative DC bus DC⁻. The negative DC bus DC⁻ (or the positive DC bus DC⁺) can also be considered to be ground. It is to be noted that the rectifier 27 could also be implemented using active components instead of diodes, e.g. transistors and/or thyristors. Whenever used herein, the phrase DC bus voltage denotes the voltage between the positive DC bus DC⁺and the negative DC bus DC⁻.

Once converted to DC, the energy can be stored in an energy storage device 7. The energy storage device 7 can e.g. be in the form of a battery, capacitor, supercapacitor, etc. The energy storage device 7 can contain a single energy storage element or a plurality of energy storage elements.

The electrical energy in the energy storage device 7 can be used to power a controller 8 and optionally any auxiliary sensors and/or actuators.

The generator 9 acts as braking force on door movement since it consumes mechanical energy to convert into electrical energy. By controlling how much electrical energy is taken out of the generator, the breaking can be controlled, i.e. dynamic breaking is achieved. The braking over time can thus be controlled to follow a predetermined movement profile for door closing.

However, when a large amount of energy is harvested, resulting in a high load on the generator, this causes phase voltages to decrease. Hence, when a slow-moving door is desired, i.e. a high breaking effect, the generator loading shall be high which results in a plummeting voltage. When the DC bus voltage drops below a voltage threshold that is required to enable charging, no power transfer can occur. If this is not addressed, the efficiency and user experience is seriously affected.

According to embodiments presented herein, the controller 8 is configured to ensure that the energy storage device is supplied with energy of suitable characteristics for charging the energy storage device 7. Specifically, the controller 8 can measure the voltage of the DC power on the DC bus, which is used supply energy to the energy storage device 7, or the AC voltage supplied by the generator 9. When it is detected that a voltage (directly or indirectly) energised by the generator drops below a threshold voltage (resulting in a voltage being below an operative voltage range for charging the energy storage device 7), the controller 8 activates a voltage boost circuit to increase the voltage of the DC energy that is supplied to the energy storage device 7. The detected voltage can be the DC bus voltage, or an AC voltage supplied by the generator. In this way, proper charging of the energy storage device 7 is provided.

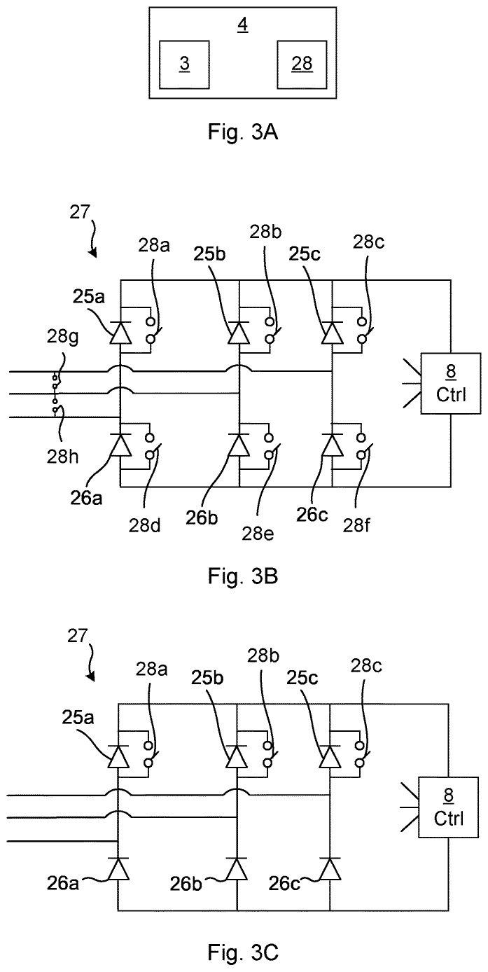

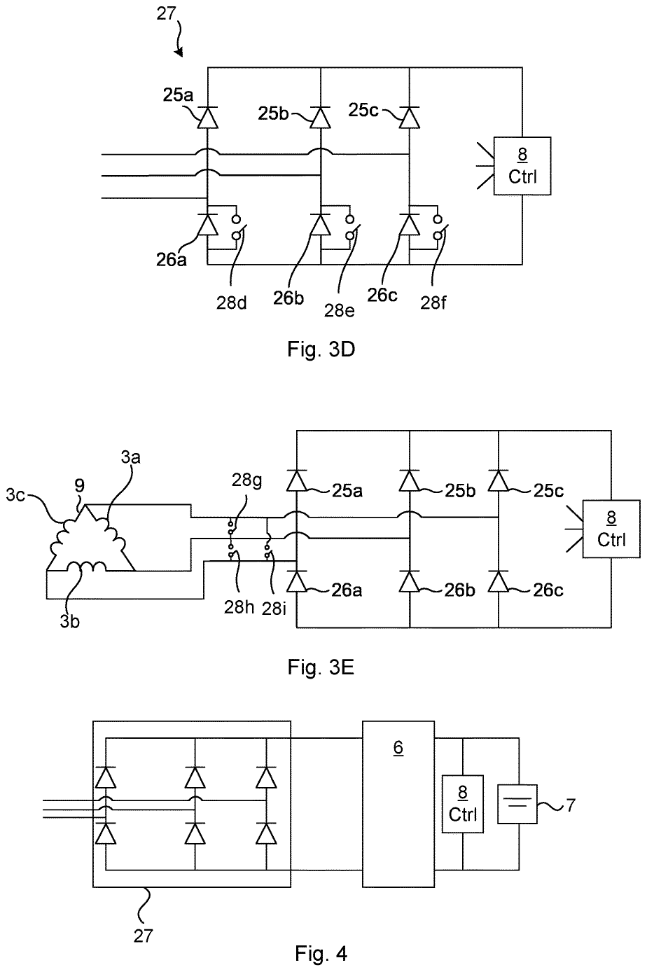

FIGS. 3A-E are schematic diagrams illustrating embodiments of voltage boost circuit. Looking first to FIG. 3A, it is illustrated a voltage boost circuit 4 comprising at least one switch 28 and at least one winding 3 (of the generator 9). The switch 28 is arranged to selectively connect and disconnect energy transfer from the generator 9 to the energy storage device. Specific embodiments of placement of the switch(es) are illustrated in FIGS. 3B-E and are described below. When energy transfer occurs from the generator 9 to the energy storage device 7, a current induced from mechanical movement flows through the winding(s) 3. When the voltage (in DC or AC form) supplied by the generator drops below a threshold voltage, the controller 8 operates the switch(es) 28 of the voltage boost circuit 4 to provide a low impedance path for the winding(s) 3, and thus reduces load seen by the windings, e.g. by short circuiting the winding(s). The winding(s) 3 act as inductor(s) and are thus current stiff, resulting in voltage increase when their perceived load is reduced. When the voltage has increased sufficiently, the controller 8 operates the switch(es) 28 again to remove the low impedance path, to supply energy to the energy storage device 7. The resulting electrical load may, after a while, result in the voltage dropping again, whereafter the process is repeated to again boost the voltage, etc. The duty cycle between open and closed switches, i.e. pulse width modulation (PWM), can be dynamically controlled or statically configured to achieve suitable balance between mechanical breaking and voltage range for the energy storage device.

By exploiting the winding(s) 3 of the generator as inductors in the voltage boost circuit 4, no additional inductors need to be provided. This results in an efficient implementation of the voltage boost circuit with low component count and cost.

Looking now to FIG. 3B, it is here shown a first switch 28a, a second switch 28b and a third switch 28c provided in parallel to respective upper diodes 25a-c.

A fourth switch 28d, a fifth switch 28e and a sixth switch 28f are provided in parallel to respective lower diodes 26a-c.

A seventh switch 28g is provided between the first AC output 22a and the second AC output 22b. An eighth switch 28h is provided between the second AC output 22a and the third AC output 22c.

One or more of the switches 28a-h can selectively be closed to provide a low impedance path as seen from one or more of the windings 9 of the generator 3.

As explained above, the controller 8 is configured to control the state of the switches 28a-h such that, in conjunction with the winding(s) 3, a suitable voltage is provided to the energy storage device 7 for it to charging energy. In other words, the switches 28a-h are used to create a low impedance path between the generator windings 9. That can be achieved using multiple combinations of the switches seen in FIG. 3B. In one scenario, the fourth switch 28d, the fifth switch 28e and the sixth switch 28f are closed. In one scenario, the seventh switch 28g and the eighth switch 28h are closed. In one scenario, the seventh switch 28g, the first switch 28a and the fourth switch 28d are closed.

The number of switches 28a-h can be applied as appropriate to achieve a desired balance between controllability and cost. More switches allow greater load reduction with results in faster voltage increase, but more switches also increase cost. A few of such embodiments are illustrated in FIGS. 3C-E.

FIG. 3C illustrates an embodiment where only the first switch 28a, the second switch 28b and the third switch 28c of FIG. 3B are used.

FIG. 3D illustrates an embodiment where only the fourth switch 28d, the fifth switch 28e and the sixth switch 28f of FIG. 3B are used.

FIG. 3E illustrates an embodiment where the seventh switch 28g, and the eighth switch 28h and a ninth switch 28i are used for voltage boost. As explained above, the generator 9 comprises multiple phases and windings 3a-c are provided between each pair of phases. In this embodiment there are three potential switches 28g, 28h, 28i that can be closed to short-circuit a corresponding winding of the generator. In this example, the seventh switch 28g can short-circuit a first winding 3a, the eighth switch 28h can short-circuit a second winding 3b and the ninth switch 28i can short-circuit a third winding 3c (each of these corresponding to the switch 28 and winding 3 of FIG. 3A).

In this case, the control circuit 8 is configured to select the at least one switch to close for voltage boost from the plurality of potential switches 28g-i. Moreover, the control circuit 8 is configured to distribute the selection over time among all of the plurality of potential switches 28g-i. For instance, the control circuit 8 can be configured to distribute the selection over time among all of the plurality of potential switches to approach an even distribution among all of the plurality of potential switches. By spreading the use between the potential switches, wear and heat dissipation, among components such as windings and switches, is distributed to extend life span of the energy converter.

The selection of which embodiment, e.g. of those illustrated in FIGS. 3B-E can also depend e.g. on space limitations on a printed circuit board (PCB) implementation. The embodiment of FIG. 3E is particularly component efficient, but power dissipation is there shared between two devices and instead of three in the other embodiment.

FIG. 4 illustrates an embodiment of a voltage boost circuit 6 that is provided between the rectifier 27 and the energy storage device 7 of FIG. 2. The voltage boost circuit 6 takes DC power from the rectifier 27 as input and provides DC power as output to the energy storage device 7. In other words, the voltage boost circuit 6 is here in the form of a DC/DC converter.

By providing a DC/DC voltage boost circuit 6, the voltage boost circuit 6 can be implemented in any suitable way and there is a lot of freedom of design of the voltage boost circuit 6. The function and control of the voltage boost circuit 6 is the same as the voltage boost circuit 4 described above, e.g. in terms of duty cycle, etc.

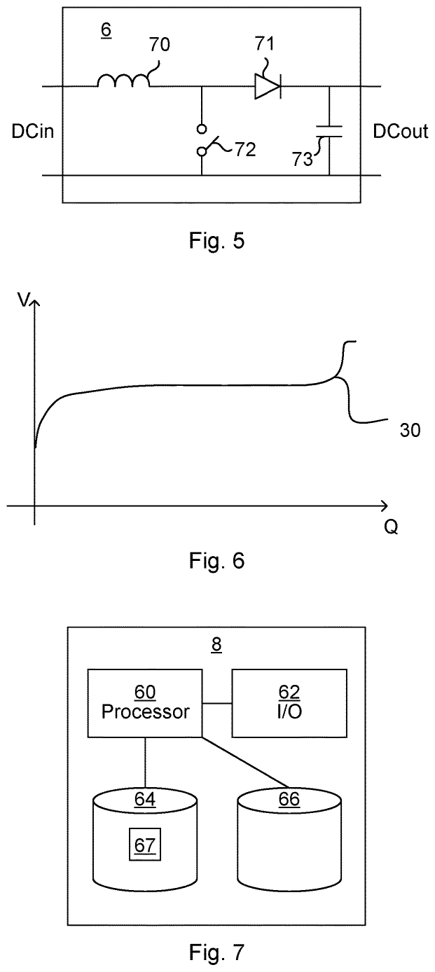

FIG. 5 is a schematic diagram illustrating an embodiment of the voltage boost circuit 6 of FIG. 4. An inductor 70 is provided in series with a diode 71 on the positive DC side between the input DCᵢₙ and the output DCₒᵤₜ. A switch 72 is provided to selectively shortcut the positive DC bus (after the inductor) with the negative DC bus of the circuit. Optionally, a smoothing capacitor 73 is provided between the terminals of the output DCₒᵤₜ to reduce voltage variations on the output DCₒᵤₜ. The function of the voltage boost circuit 6 is the same as the voltage boost circuit 4 described above. In other words, the current stiff inductor 70 is selectively shortcut by the switch 72 to increase the voltage provided.

FIG. 6 is a schematic graph illustrating how the threshold voltage 30 can vary depending on charge level Q in the energy storage device 7. The vertical axis represents voltage V, and the horizontal axis represents charge level Q, e.g. in per cent of maximum charge of the energy storage device. In this example, from an increasing charge level, the threshold voltage 30 starts low and relatively quickly reaches a flat level. When the charge level Q increases to a high level, the threshold voltage 30 increases again.

This relationship between charge level and threshold voltage can be used by the energy converter. Specifically, the energy first determines a charge level Q in the energy storage device 7, e.g. by measurement. Subsequently, the energy converter can determine a threshold voltage 30 based on the charge level and a mapping between charge level and threshold voltage. That mapping can correspond to the threshold voltage 30 plotted in FIG. 6 against the charge level. In practice, the mapping can be stored as a lookup table where the threshold voltage 30 can be looked up based on a charge level Q. In this way, the threshold voltage can adapt and increase when needed (e.g. at the right end of the plot in FIG. 6), while the threshold voltage can remain lower for other charge levels and can be even lower at very low charge levels (see the very left end of the plot in FIG. 6). Consequently, an appropriate and sufficient, but not an excessive (which would not be energy efficient), threshold voltage is applied for different values of charge level.

It is to be noted that, while not reflected in FIG. 6, the charging of the energy storage device may also depend on a movement profile for the door closer. In this way, the braking over time can be controlled to follow a predetermined movement profile for door closing. When both these profiles are used, the movement profile is the first profile that is followed, determining when to charge the energy storage device, to thereby control the braking. Secondarily, when braking is to be applied, the threshold voltage determined based on the charge level (as illustrated in FIG. 6) is used to determine when the boost circuit is to be activated.

FIG. 7 is a schematic diagram illustrating components of the controller 8 of FIG. 1 according to one embodiment. A processor 60 is provided using any combination of one or more of a suitable central processing unit (CPU), graphics processing unit (GPU), multiprocessor, neural processing unit (NPU), microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIG. 4 below.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

The controller 8 further comprises an I/O interface 62 for communicating with external and/or internal entities.

Other components of the controller 8 are omitted in order not to obscure the concepts presented herein.

Embodiments presented herein provide improved energy transfer from a generator to an energy storage device, particularly in the case that a high breaking force is desired on the mechanical side of the generator. Efficiency is improved since it can be ensured that the voltage range for charging the energy storage device is complied with. Also, by ensuring the voltage is within operating rang for charging, the control of electrical load and thus breaking is improved since the breaking force is controllable for a greater proportion of time. The duty cycle of the voltage boost circuit can be used as included in a control loop to regulate the behaviour of the generator and for controlling door movement. The control loop can affect the duty cycle of the PWM of the voltage boost circuit based on various parameters, such as desired breaking force, voltage on the AC output(s), DC voltage across the energy storage device, temperature, current, angular velocity of the door, generator rotation speed, time of day, etc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An energy converter for converting mechanical energy to electrically stored energy, the energy converter comprising:
a generator comprising at least one winding;
an energy storage device;
a rectifier provided between the generator and the energy storage device;
a voltage boost circuit that is selectively activated;
a control circuit that is configured to:
determine a charge level in the energy storage device:
determine a threshold voltage based on the charge level:
detect that a voltage that is energised by the generator is below the threshold voltage; and
activate the voltage boost circuit of the energy converter to increase a voltage supplied to the energy storage device in response to detecting that the voltage that is energised by the generator is below the threshold voltage.

2. The energy converter according to claim 1, wherein the voltage energised by the generator is a DC output voltage of the rectifier.

3. The energy converter according to claim 1, wherein the voltage boost circuit comprises at least one winding of the generator and at least one switch.

4. The energy converter according to claim 3, wherein the at least one switch is arranged to selectively connect and disconnect energy transfer from the generator to the energy storage device.

5. The energy converter according to claim 3, wherein the at least one switch (28) is provided in the rectifier.

6. The energy converter according to claim 5, wherein the rectifier comprises diodes, and wherein at least one of the at least one switch is provided in parallel to a first one of the diodes.

7. The energy converter according to claim 3, wherein the generator is a multi-phase generator, and wherein at least one of the at least one switch is provided between two phases of the multi-phase generator.

8. The energy converter according to claim 7, wherein the control circuit is configured to select the at least one switch from a plurality of potential switches, and wherein the control circuit is configured to distribute selection over time among all of the plurality of potential switches.

9. The energy converter according to claim 8, wherein the control circuit is configured to distribute selection over time among all of the plurality of potential switches to approach an even distribution among all of the plurality of potential switches.

10. (canceled)

11. The energy converter according to claim 1, wherein the voltage boost circuit is a boost converter provided between the rectifier and the energy storage device.

12. The energy converter according to claim 1, wherein the control circuit comprises a processor; and a memory storing instructions that, when executed by the processor, cause the energy converter to perform the operations it is configured to perform.

13. A door closer comprising the energy converter according to claim 1.
